(19) United States
(12) Patent Application Publication
(10) Pub. No.: US 2015/0128057 A1
(43) Pub. Date: May 7, 2015

(54) Remote Monitoring an Individual's Adherence to a Personalized Schedule

(71) Applicant: Kevin O'Sullivan, Dublin (IE)

(72) Inventors: Kevin O'Sullivan, Dublin (IE); Gavin Soady, Clane (IE)

(21) Appl. No.: 14/535,967

(22) Filed: Nov. 7, 2014

(30) Foreign Application Priority Data
Nov. 7, 2013 (IE) S2013/0341

(51) Int. Cl. H04L 29/08; G06F 3/0484

(52) U.S. Cl. CPC H04L 67/025; G06F 3/0484
USPC 715/738

(57) ABSTRACT

A computer-implemented method for remotely monitoring an individuals adherence to a personalised schedule includes receiving primary data inputs associated with an individual from a client device and generating a schedule based on the primary data inputs. The method also includes inputting secondary data inputs to the client device which provides feedback on the individual adherence to the generated personalised schedule, providing a graphical representation on the client device based on the secondary data inputs which provides a visually perceptible representation of the individual's adherence to the generated schedule, and providing a remote device access to the graphical representation for facilitating remote monitoring of the individual's adherence to the generated personalised schedule.

### CROSS-REFERENCE TO RELATED APPLICATIONS

This application claims priority to Irish Patent Application S2013/0341 filed on Nov. 7, 2013 and entitled “A method and system for remotely monitoring an individual's adherence to a personalised schedule,” the entire contents of which are hereby incorporated by reference for any and all purposes.

### FIELD OF THE INVENTION

The present teaching relates to a method and system for remotely monitoring an individual's adherence to a personalised schedule.

### BACKGROUND

With the emergence of smart devices the ability to capture large amounts of user data has vastly increased. Software applications residing on smart phones are known to measure various parameters when a person is exercising. For example, smart phones with GPS capabilities have the capability to track and map an individual's route while jogging, walking, skiing, etc. Such devices are known to calculate the speed and the distance traveled as well as estimate calories burnt during an exercise routine. A graphical representation of the captured parameters for an individual may be provided on a graphical user interface. Such graphical representations are accessible on the user's local device and typically only focuses on a single aspect of an individuals well being such as exercise. Capturing large amounts of user data creates a problem of how to present the captured data in a meaningful fashion on smart devices who have a limited display area and processing power.

There is therefore a need for a method and system for remotely monitoring an individual's adherence to a personalised schedule.

### SUMMARY

The present teaching relates to a method and system for remotely monitoring an individual's adherence to a personalised schedule. In particular, the present teaching relates to generating a graphical representation which provides a visually perceptible representation of an individual's adherence to a generated personalised schedule and remotely monitoring thereof. Furthermore, the present teaching relates to using generated representations associated with a plurality of individuals to monitor the performance of a group of individuals.

In one aspect there is provided a computer-implemented method for remotely monitoring adherence to a schedule, the method comprising:

receiving primary data inputs associated with an individual from a client device,

generating a personalised schedule based on the first data inputs,

inputting secondary data inputs to the client device which provides feedback on the individual adherence to the generated personalised schedule,

providing a graphical representation on the client device based on the secondary inputs which provides a visually perceptible representation of the individual's adherence to the generated personalised schedule, and

providing a remote device access to the graphical representation for facilitating remote monitoring of the individual's adherence to the generated personalised schedule.

In another aspect the graphical representation has an associated weighting. Advantageously, the graphical representation includes indicators which reflects the associated weighting thereof. Ideally, the method further comprises forwarding messages between the remote device and the client device. Preferably, the content of the messages are linked to the weighting of the graphical representation.

In a further aspect a plurality of individuals each have associated client devices for inputting primary data inputs and secondary data inputs thereto. Advantageously, a graphical representation is generated for each individual which provides a visually perceptible representation of the respective individual's adherence to a corresponding generated schedule. Ideally, the plurality of graphical representations are provided to the remote device for displaying thereon. Preferably, the graphical representations are filtered based on their associated weighting for displaying on the remote device.

In one aspect a plurality of individuals are grouped together. Advantageously a plurality of groups are provided. Preferably, each group has an associated weighting determined by summing the secondary data inputs received from the individuals of the respective group. Ideally, each group has an associated graphical representation which provides a visually perceptible representation of the group's overall weighting. Advantageously, the graphical representation of each group is provided to the remote device for displaying thereon.

In one aspect the primary data inputs include at least one of gender, age, height, weight, shape, and goals. Advantageously, the primary data inputs are used to set a base level for the personalised schedule. Ideally, the graphical representation is configured to indicate one of a plurality of levels. Preferably, the graphical representation is set to indicate a default level.

In another aspect the secondary data inputs includes at least one of exercise data, nutritional data, weight, hydration, heart rate, and activity level. Advantageously, each secondary data input has an associated weighting. Ideally, each secondary data input has an associated avatar for providing a visually perceptible graphical representation of the associated value.

### BRIEF DESCRIPTION OF THE DRAWINGS

The present teaching will now be described with reference to the accompanying drawings in which:

FIG. 1 is a block diagram of a system for remotely monitoring an individual's adherence to a personalised schedule in accordance with the present teaching.

FIG. 2 is a block diagram of a detail the system of FIG. 1.

FIG. 3 is a block diagram of a detail the system of FIG. 1.

FIG. 4 is a diagrammatic illustration of a visually perceptible representation of an individual's adherence to the personalised schedule.

FIG. 5 is a diagrammatic illustration of a plurality of visually perceptible representations associated with corresponding individuals.

FIG. 6 is a diagrammatic illustration of a plurality of visually perceptible representations associated with groups of individuals.

FIG. 7A is a diagrammatic illustration of a graphical user interface in accordance with the present teaching.

FIG. 7B is a diagrammatic illustration of a graphical user interface in accordance with the present teaching.

### DETAILED DESCRIPTION OF THE DRAWINGS

The present teaching will now be described with reference to a system for remotely monitoring an individual's adherence to a personalised schedule. It will be understood that the exemplary system is provided to assist in an understanding of the present teaching and is not to be construed as limiting in any fashion. Furthermore, modules or elements that are described with reference to any one Figure may be interchanged with those of other Figures or other equivalent elements without departing from the spirit of the present teaching.

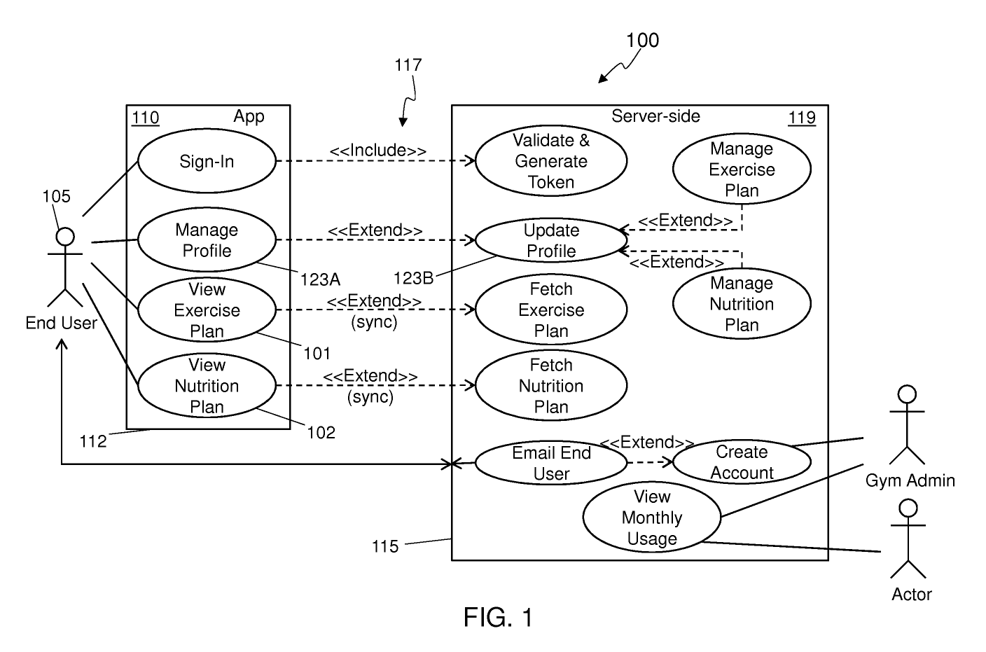

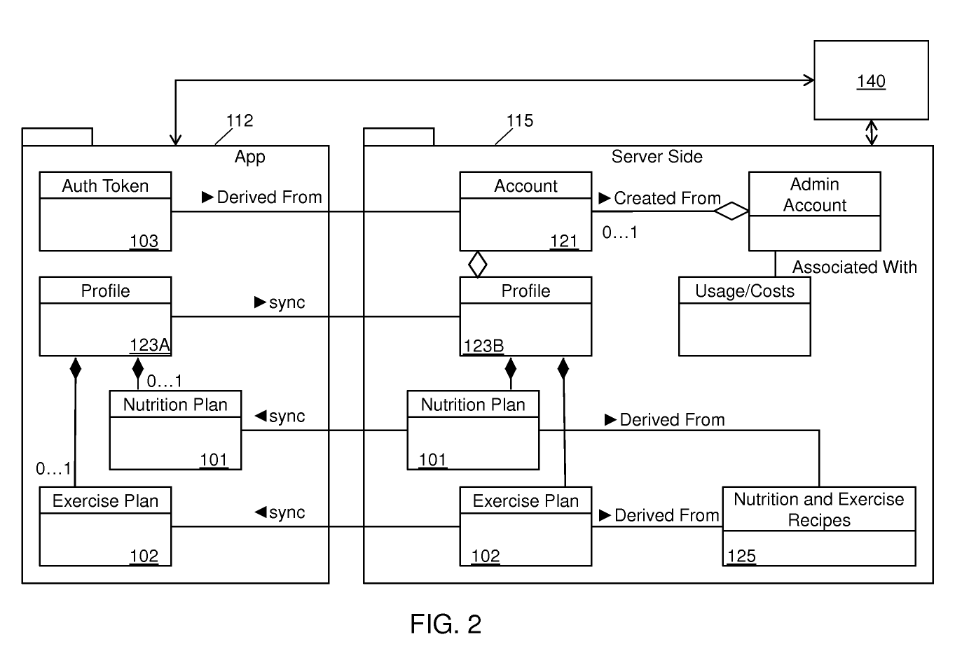

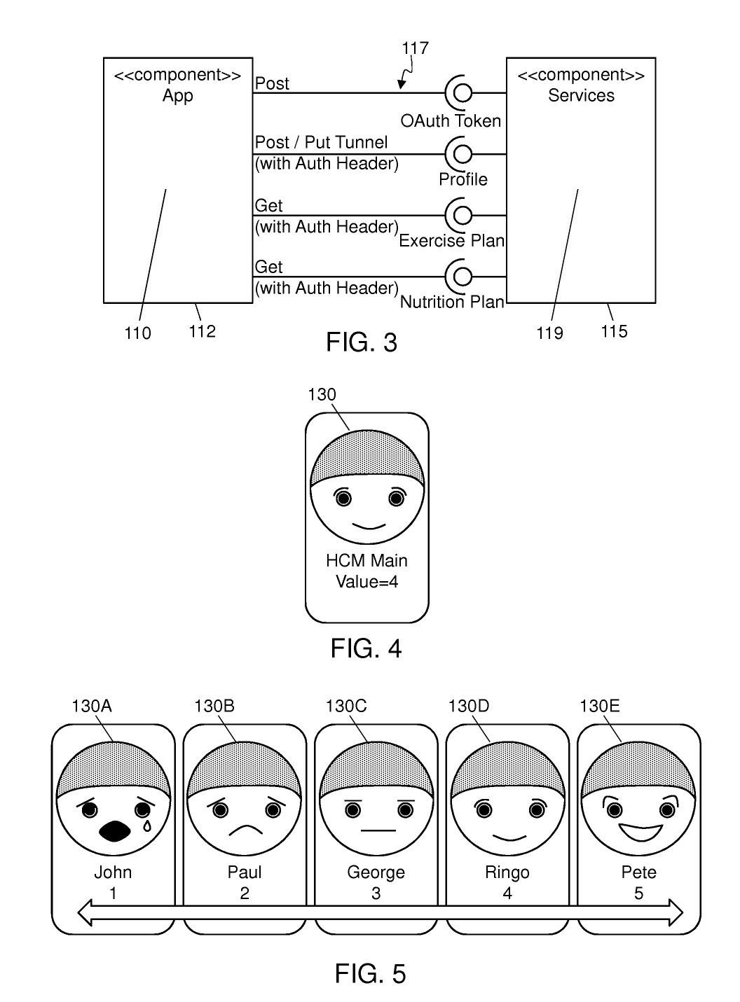

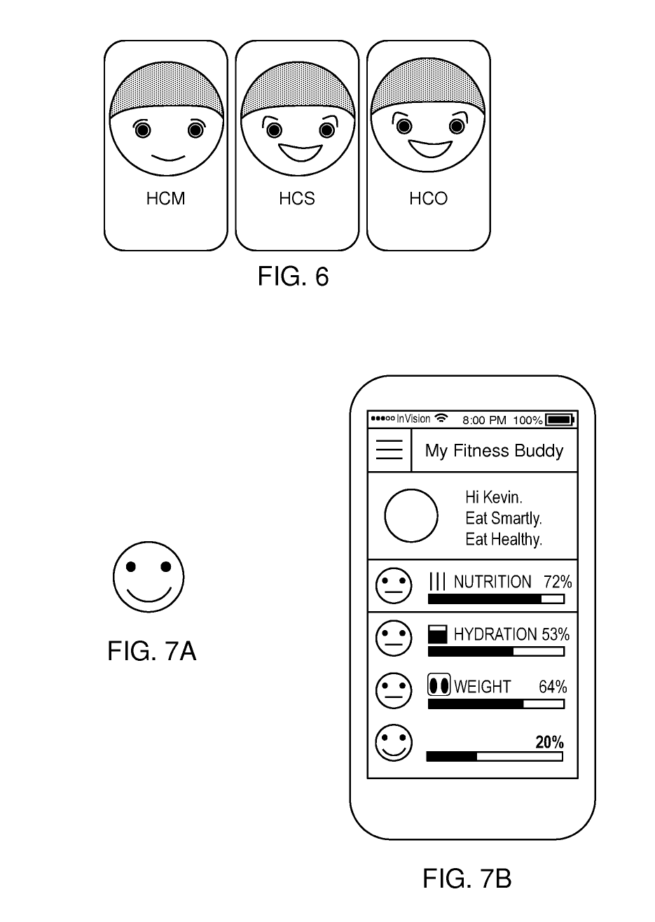

Referring initially to FIG. 1, there is provided a system 100 for remotely monitoring an individual's adherence to a personalised schedule. In the exemplary arrangement, the schedule comprises an exercise plan 101 and nutrition plan 102 for an individual 105. However, it is not intended to limit the schedule to the exemplary arrangement described herein as the schedule may include other schedule types such as personalised workflows used for tracking the completion of tasks or the like. In the exemplary arrangement, a schedule application 110 is installed on a client device 112 which is associated with the individual 105 and provides a user interface to allow the individual 105 to communicate with a central server 115 across a network 117. The client device 112 may include a portable handheld device such as a smart phone, tablet, personal digital assistant, etc. The software application 110 is configured to provide a graphical user interface (GUI) on the client device 112 which allows the user to interact with an administration application 119 executing on the server 112. Each individual registers with the administration application 119 by providing biographical details and is assigned an unique account number which may be linked to an unique identifier such as a personal identification number or password. The individual enters the unique identifier on the GUI of the schedule application 110 in order to gain access to the functionality of the schedule application 110. On entering the unique identifier the individual 105 is presented with a questionnaire on the GUI in order to extract relevant information from the individual so that the administration application 119 can generate a user profile based on the extracted information.

In the exemplary arrangement the questionnaire includes questions relating to forename, surname, e-mail address, gender, age, height, weight, shape, activity level, availability to train, goals. The goals may include for example an individual's desire to become leaner, fitter, bigger, stronger, etc. After the individual has completed the questionnaire the client device 112 pushes the completed questionnaire to the central server 112. The administration application 119 reads the data contained in the completed questionnaire and generates a personalised schedule which includes an exercise plan 101 and a nutrition plan 102. The generated schedule is viewable on the client device 112 by selecting appropriate icons on the GUI. It will therefore be appreciated that the data entered by the individual when completing the questionnaire are primary data items which are used by the administration application 119 for generating a schedule tailored for that individual.

The administration application 119 is operable to create an account which is associated with the individual 105. Details of how to access the account may be emailed to the individual 105 or sent by SMS message or communicated via some other means. The individual 105 can sign in on the schedule application 110 using the unique identifier such as a password. To ensure that password is not saved on the client device 112 a time limited password token may be created which will be used by the application 110 for all subsequent logins. Once logged into the application 105 the individual is able to create a basic profile 123A which is synced back to a corresponding profile 123B in the account 121 for the individual 105 on the central server 115. A module 125 of the administration application 119 reads the data contained in the profile 123B and is configured to generate a personalised nutrition plan 101 and a personalised exercise plan 101 for the individual 105 based on the read data. When the individual selects the exercise plan or nutrition plan icons on the GUI the respective plans are fetched by the client device 112 from the central server 115.

The application 110 is configured to provided a visually perceptible representation of the individual's adherence to the generated personalised schedule. In the exemplary arrangement, an avatar, such as the avatar 130 shown in FIG. 4, is displayed on the GUI of the client device 112. The avatar has an associated weighting which reflects the individual's adherence to the generated personalised schedule. For example, five facial expressions 130A-130E are illustrated in FIG. 5 each indicating a level of adherence with the generated personalised schedule. The level of adherence progressively increases from avatar 130A to avatar 130E. Before the individual attempts to comply with the generated schedule a default avatar 130C is displayed on the GUI on the client device 112. Depending on the individual's adherence to their personalised schedule the central server 115 will update which avatar 130A-130E to display for that user.

This primary data items entered by the individual when answering the questionnaire are used to set a baseline for the schedule. How the individual follows their plan will dictates the status of their avatar 130. The five levels of FIG. 5 are as follows:

Avatar 130E Level 5=Excellent Performance

Avatar 130D Level 4=Good Performance

Avatar 130C Level 3=Average Performance

Avatar 130B Level 2=Below Average Performance

Avatar 130A Level 1=Poor Performance

As the individual 105 follows the nutrition plan 101 and exercise plan 102 they enter nutritional and exercise data on GUI of the client device 112. These secondary data items entered by the user on the client device 112 are synched with the central server 119 which controls the expression on the avatar 130 to reflect the appropriate level of adherence to the personalised schedule. For example, the facial expression on the avatar 130E indicates that Pete has an excellent adherence to his personalised schedule while the facial expression on the avatar 130A indicates that john is performing poorly. A copy of the avatars 130A-130E are stored on the central server 115 in the respective user accounts. A remote device 140 is operable to communicate with the central server 119 for reviewing the avatars 130A-130E for facilitating remotely monitoring of the individuals adherence to their respective schedules. One or more remote devices 140 are operable to fetch the avatars 130A-130E from the central server 119 for displaying thereon. The remote devices 140 may be associated with a personal trainer or a nutritional expert, for example. It will therefore be appreciated by those of ordinary skill in the art that an individual's adherence to their personalised schedule may be remotely monitored in real time by fetching the appropriate avatar 130 from the central server 115 using remote devices. The user of the remote device 140 is able to send messages to the client device 112, and vice versa. In this way a personal trainer is able to communicate messages of encouragement or advice with the individual in real time if he notices that the individual is under performing.

In operation, once the questionnaire is completed by the individual 105 the central server 119 sets the avatar to a default level. The schedule application 110 sends the primary data items to the module 125 on the server which returns the personalised nutrition plan 101 and the personalised exercise plan 102 to the client device 112. The schedule application 110 then tracks secondary data items which are inputted by the individual when following the personalised schedule. The secondary data items may include but not limited to exercise data, nutritional data, weight, hydration, heart rate, activity levels etc. These secondary data items have a weighting applied to them. In the example, the weighting ranges from 1 through to 5. It will be appreciated that alternative weighting levels may be employed. Depending on how the individual is performing the central server controls the expression on the avatars face. A personal trainer is able to log into the administration application 119 using the remote device 140 and remotely monitor how the individual is performing by fetching the individuals avatar. In one arrangement, the personal trainer has a number of individuals which he is responsible for monitoring their performance. In this scenario, the central server 115 pushes the avatars 130A-130E for each individual that the personal trainer is responsible for to the remote device 140 so that the personal trainer can remotely monitor each person. Individuals who are performing poorly require more attention from the personal trainer than individuals who are performing excellently. Thus the avatars 130A-130E are displayed on the device 140 in a filtered fashioned with the worst performing individuals being prioritised for displaying at the top of the list. The personal trainer can scroll through the avatars on the device 140 and select any one of the avatars 130 and drill down to view more detailed information that the user entered when tracking their performance while completing their personalised schedule. Thus applying a weighting to the avatars 130 and by filtering them for displaying allows the personal trainers to quickly locate individuals who need urgent attention.

It will be appreciated that in any health club a personal trainer is responsible for a large number of individuals. It also desirable to monitor the performance of each personal trainer by monitoring how each personal trainer is performing. In that regard a number of individuals are grouped together and their overall performance is summed together. The present teaching provides a hierarchical arrangement which allows different levels of the hierarchy to monitor the performance of those below them. The hierarchical structure could include a number of different layers in a tree data structure arrangement, for example:

First Layer=Health Club Members (HCM)

Second Layer=Health Club Staff (HCS)

Third Layer=HCO—Health Club Owner (HCO)

The first layer is the lowest level in the hierarchical structure with the second layer located intermediate the first and third layers. The central server 115 is operable to generate an avatar for each layer which reflects how the person at each level is performing. It will be appreciated that the HCS may be responsible for a plurality of HCMs. The secondary data items provided by each HCM may be summed together to generate an appropriate weighting for the HCS who is responsible for the HCMs. The avatar linked with the HCS will indicate the appropriate weighting. Similarly, the HCO may responsible for a plurality of HCSs. Parameters which are provided by each HCS may be summed together to generate an appropriate weighting for the HCS who is responsible for the HCSs. The avatar linked with the HCS will indicate the appropriate weighting.

The emoticon of FIG. 7A is a graphical representation of an individuals's results for the day and an indication of their over all adherence to their schedule. In this example, the individual achieved a 53.7% adherence level which is indicated by the extend of the smile on the emoticon. The emoticon summaries the four weighted elements, namely, Nutrition 72%, Hydration 53%, Weight 64% and Heart rate/Exercise20%.

| | Nutrition: | Hydration: | Weight: | Heart rate/exercise |
|---|---|---|---|---|
| Percentage % | 72% | 53% | 64% | 20% |
| Weighting of | 5 | 1 | 1 | 3 |

This person has hit 72% of their nutrition goals due to feedback or results for the day. Each element has a weighting. For example, nutrition is 5 times more important than hydration. The management system is configured to be updated due to feedback, logging, results and data received. Individual elements e.g. Nutrition/weight, receives information from various sources which may be increased, decreased or varied as research dictates. In the exemplary system, four elements (Nutrition: Hydration: Weight: Heart rate/exercise) are used but it will be appreciated that more elements may be used, for example, sleep patterns. The weightings between the different elements can be adjusted as research dictates.

FIG. 7B is example of a graphical user interface displaced on the home screen. A total of 5 emotive smiley faces valued at 20% each totaling 100% ranging from a happy expression to a sad expression. ONE over all emoticon (smiley face), summaries the 4 elements by getting the weighted average from each of the 4 individual elements. Each of the elements are weighted in order of importance, for example, nutrition could be weighted 50% against Hydration, which is weighted at 10%. No matter how many individual elements used the total will add up to 100%. Receiving accurate measured data from wearable smart technology, physical measuring people in the gyms, members feed back, members logging information will also change weighting over time e.g. so today nutrition is weighted at 50% but the feed back and the research might dictate and end up telling us to increase nutrition weighting up to 53.7% as the system gets in more information it will be come more accurate and more beneficial for the users.

It will be understood that what has been described herein is an exemplary system for remotely monitoring an individual's adherence to a personalised schedule. While the present teaching has been described with reference to exemplary arrangements it will be understood that it is not intended to limit the teaching to such arrangements as modifications can be made without departing from the spirit and scope of the present teaching. The method of the present teaching may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the first, second, third and fourth modules as described above. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules. In the example of heretofore described, the software in memory includes the one or more components of the method and is executable on a suitable operating system (O/S).

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. Any process descriptions or blocks in the Figures, should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

While the present teaching has been described with reference to exemplary applications and modules it will be understood that it is not intended to limit the teaching of the present teaching to such arrangements as modifications can be made without departing from the spirit and scope of the present invention. In this way it will be understood that the present teaching is to be limited only insofar as is deemed necessary in the light of the appended claims.

Similarly the words comprises/comprising when used in the specification are used to specify the presence of stated features, integers, steps or components but do not preclude the presence or addition of one or more additional features, integers, steps, components or groups thereof.

1. A computer-implemented method for remotely monitoring an individuals adherence to a personalised schedule, the method comprising:
receiving primary data inputs associated with an individual from a client device,
generating a schedule based on the primary data inputs,
inputting secondary data inputs to the client device which provides feedback on the individual adherence to the generated personalised schedule,
providing a graphical representation on the client device based on the secondary data inputs which provides a visually perceptible representation of the individual's adherence to the generated schedule, and
providing a remote device access to the graphical representation for facilitating remote monitoring of the individual's adherence to the generated personalised schedule.

2. A method as claimed in claim 1, wherein the graphical representation has an associated weighting.

3. A method as claimed in claim 2, wherein the graphical representation includes indicators which reflects the associated weighting thereof.

4. A method as claimed claim 3, further comprising forwarding messages between the remote device and the client device.

5. A method as claimed in claim 4, wherein the content of the messages are linked to the weighting of the graphical representation.

6. A method as claimed in claim 1, wherein a plurality of individuals each have associated client devices for inputting primary data inputs and secondary data inputs thereto.

7. A method as claimed in claim 6, wherein a graphical representation is generated for each individual which provides a visually perceptible representation of the respective individual's adherence to a corresponding generated personalised schedule.

8. A method as claimed in claim 7, wherein the plurality of graphical representations are provided to the remote device for displaying thereon.

9. A method as claimed in claim 8, wherein the graphical representations are filtered based on their associated weighting.

10. A method as claimed in claim 7, wherein the individuals are grouped together.

11. A method as claimed in claim 10, wherein a plurality of groups are provided.

12. A method as claimed in claim 11, wherein each group has an associated weighting determined by each of the individuals secondary data inputs of the respective group.

13. A method as claimed in claim 12, wherein each group has an associated graphical representation which provides a visually perceptible representation of the group's overall weighting.

14. A method as claimed in claim 13, wherein the graphical representation of each group is provided to the remote device.

15. A method as claimed in claim 1, wherein the primary data inputs include at least one of gender, age, height, weight, shape, and goals.

16. A method as claimed in claim 15, wherein the primary data inputs are used to set a base level for the recommended schedule.

17. A method as claimed in claim 15, wherein in claim 16, wherein the graphical representation is configured to indicate one of a plurality of levels.

18. A method as claim in claim 17, wherein the graphical representation is set to indicate a default level.

19. A method as claimed in claim 1, wherein the secondary data inputs includes at least one of exercise data, nutritional data, weight, hydration, heart rate, and activity level.

20. A method as claimed in claim 19, wherein each secondary data input has an associated weighting.

21. A method as claimed in claim 20, wherein each secondary data input has an associated avatar for providing a visually perceptible graphical representation of the associated value.
